(19) United States
(12) Patent Application Publication
(10) Pub. No.: US 2016/0298357 A1
(43) Pub. Date: Oct. 13, 2016

(54) Old fence privacy kit

(71) Applicant: Jijun Liu, Sacramento, CA (US)

(72) Inventor: Jijun Liu, Sacramento, CA (US)

(21) Appl. No.: 14/545,213

(22) Filed: Apr. 7, 2015

(51) Int. Cl. E04H 17/14; F16B 19/04

(52) U.S. Cl. CPC E04H 17/1426; F16B 19/04; E04H 2017/1447

(57) ABSTRACT

To put wood boards into the notches of a 70 inch long, 1 or 1.5 inch wide of “H” form PVC strips when building a new fence would prevent gaps and would solve wood fence privacy issue. To cover gaps, holes and cracks on a old fence with arc form PVC strips, round and rectangular wood grain pieces which I designed old fence kit would easily solve wood fence privacy problem. I designed a fastener composed of a male and female of two part which I called EZ rivet. Just insert a male into female, they would be griped by their reverse teeth, then press the two part together with fingers would fasten all the covering pieces on the fence. It would fasten any objects and materials, It would be easy to use and no special tool needed.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### REFERENCE TO SEQUENCE LISTING, A TABLE, OR A COMPUTER PROGRAM LISTING COMPACT DISC APPENDIX

(Not Applicable)

### BACKGROUND OF THE INVENTION

The idea of my invention came from my backyard wood fence. My fence was built 8 years ago, and it became old since then. There are a lot gaps between wood boards because they have been dried and shank after many years. I can see people through it, and they can see me too. I realized that I don't have any privacy with those gaps on the fence. In order to solve the problem, I went to The Home Depot, Lowe's, Ace and other home improvement stores to find a solution. Unfortunately, I didn't find anything specially for it. I noticed that some people use overlapping wood boards to cover the gaps as their solutions, but it would cost a lot labor, time and expenses. I was thinking if there is another way or an option for people to chose for solving the problem, also save their time, labor and costs. The answer is: Yes.

AT the first, I was thinking about a solution to prevent the gaps when building a new fence. Then I thought about a “H” form strip would be a good idea for it because it has two notches on each side. If I put a wood board into the notch on each side, it would cover the gap between two boards. I realized the size of the gaps on fence are deferent, they are about ⅛ inch to ⅞ inch. A standard wood fence board is 72 inches in length, the width comes with deferent sizes, and the thickness is about ¾ inch. For this reason I designed a “H” form strip with 70 inches long, 1 or 1.5 inches wide, it would be made by PVC plastic and would be solid or hollow. If I insert the strips between wood boards when building a new fence, they would cover all the gaps when the fence becomes old or dry, and you would never worry about your privacy, the problem would be solved.

Second, I was going to find a solution for old fence privacy issue. The best way to solve the gap problem is to cover it. Not only cover it with anything but specially made, good quality covering pieces. So I designed arch form PVC plastic strips with 70 inches long, 1 or 1.5 inches wide to cover all the gaps between wood boards. I also designed 5 deferent size of PVC circles and rectangular pieces to cover holes and cracks for old fence. All the PVC covering pieces would be fastened with fence by my EZ rivets which I specially designed fasteners. Therefore, an old fence privacy issue was solved too.

Third, speaking of EZ rivet, it is my another invention along with my fence privacy kit. In order to fasten covering pieces to the fence, I have to use fasteners. I can not use nails or screws to do it because they would damage covering pieces and wood boards. So I was thinking about using rivets instead. The fastener must contain a male and female of two part that would be good. I went to hard wear stores like The home depot, Lowe's and Ace etc. to find such fasteners. I have found rivets, they were good for fastening thin metal pieces but not for fastening my covering pieces to the fence. I have tried many places even on line, sadly I couldn't find what I was looking for in the market. So I decided to make it myself. First thought of mine was using the principle of two groups of opposite saw teeth bite each other to make the rivet. Of course, the rivet is composed of a male and a female of two parts, male can be short or long. When a jagged male insert into a jagged female, they would be mutually meshed together. The male part only can go in not out. If it is used in conjunction with the two objects, can be achieved the purpose of riveting. At beginning, I designed a female was a hollow cylindrical form with a cap, insert a male into it. But later I found out that inserting a male in was not easy because the teeth were fixed on the female can't move unless hammer in. Then I decided to improve my design, change the fixed teeth on female to movable and contractive. I designed a female with three teeth inside of it. There is certain amount of space around the teeth, and with jagged lines on them, also with a hole in the center of it. So that would achieve the purpose of I wanted. Look from the side, redesigned female from a cylindrical form into a arc form with a certain thickness. From above, it is round, the center has a small hole, around the hole there are three separate movable teeth, the size of the hole a bit smaller than the male. When male is inserted into female, the movable teeth on female would do the movement of open and close, and it can only go in not out, and it can stop at any position, is determined by the thickness of the objects in between it. The rivet can be fixed on any material, as long as pressing male and female together with fingers, and the riveting can be completed without using a special tool, anyone can easily use it including children. So I call it a EZ Rivet. According to my research, There are no such kind of fasteners for sale in the market, it might be similar fasteners used in the industrial area, but I have not seen any like mine. I think I am the first one invented such functional fasteners, so it is an invention.

### BRIEF SUMMARY OF THE INVENTION

when we look at a old and dried fence, we would see a lot of gaps between boards. Can I do something to prevent this from happening? Yes, I can. I noticed the gap size usually is about ⅛ inch to ⅞ inch in width. I designed a “H” form PVC strip because it has two notches on each side. If I insert a 70 inches long, 1 or 1.5 inch wide “H” form PVC strip between wood boards (put board into its notches) when building a new fence, they would cover all the gaps and would make your fence better looking, also would protect your privacy. In the long ran it would save your time and money.

What we can do for an old fence with a lot of gaps, holes and cracks on it? Of course, to cover them. I designed an arc form PVC wood grain strip to cover long gaps, round and rectangular PVC wood grain pieces to cover holes and cracks. All these covering pieces would be fastened by my EZ rivets. This kit is specially designed for old fence, it is easy to use, it would save your time and costs. The most important is that it would solve your old fence privacy problem.

The fasteners which I invented for fastening old fence kit called EZ rivets. This invention was inspired by a principle of two opposite saw teeth griping each other. So I designed this fastener with a male and a female two parts. When a jagged male is inserted into a jagged female, three separate teeth inside the female will do open and close movement, the male with opposite teeth would be griped by female teeth. The male only can go in not out. By pushing this two parts together to fasten objects between them. It can be made by plastic or metal, it would fasten any materials, It would make a nice finish on both side. It could be used in both residential and industrial area. It is easy and fast to use, any people including children could use it, so I call this invention a EZ rivet.

### BRIEF DESCRIPTION OF THE SEVERAL VIEWS OF THE DRAWING

FIG. 1A: A “H” form strip covers a gap between two boards

FIG. 1B: A hollow or solid “H” form strips

FIG. 1C: New fence with “H” form strips

FIG. 2A: Old fence privacy kit

FIG. 2B: An arc form strip with 6 small holes on it

FIG. 2C: 5 deferent size of round covering pieces

FIG. 2D: 5 deferent size of rectangular covering pieces

FIG. 3A: An EZ rivet contains two part of a male and a female

FIG. 3B: A male looks like a screw with jagged lines and a large cap

FIG. 3C: A female looks like an arc form from the side

FIG. 3D: A female is an round from the top

FIG. 3E: Movable teeth inside of the female form a circle in the center from the section.

FIG. 3F: To fasten a joint by pressing male and female together then cut extra part with a cutter.

### DETAILED DESCRIPTION OF THE INVENTION

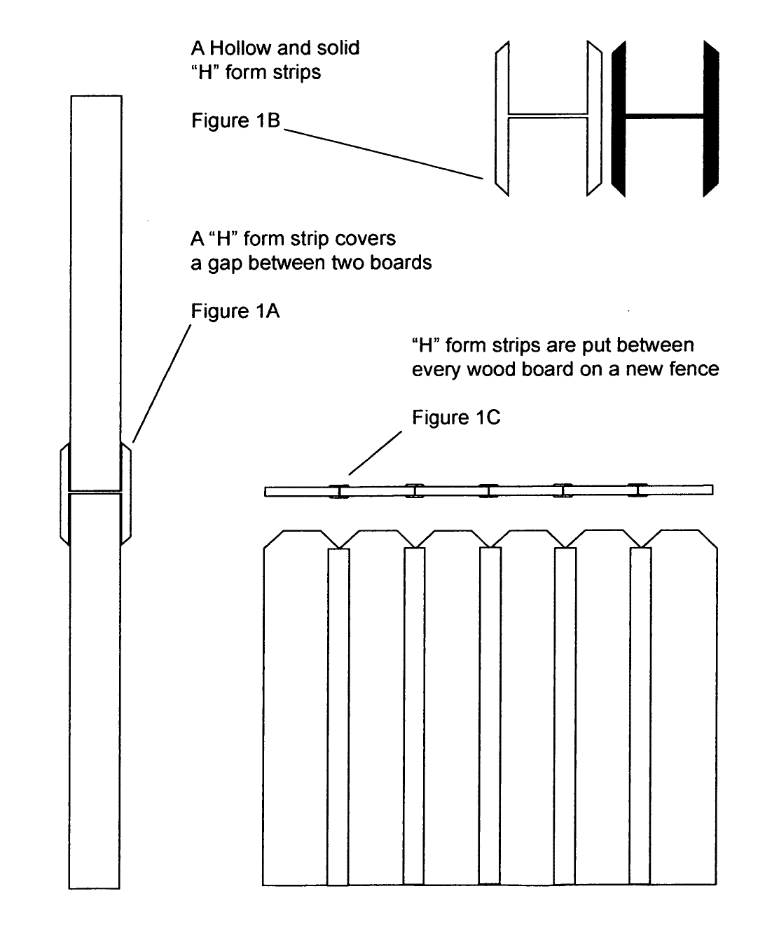

In order to solve the wood fence privacy problem, I have to know fence. I found out that the gap size between wood boards is from ⅛ inch to ⅞ inch deferent. A standard fence board is 72 inches high, the width vary in size, and the thickness is about ¾ inch. At the first, I thought about using a “H” form strip because it has two notches on each side. If I insert two boards into its notches, it would cover the gap between two boards (FIG. 1A). Next, I came up two designs of hollow and solid looking of “H” form strips (FIG. 1B). Then I was thinking about using PVC plastic to make it because PVC plastic would be durable and economical. Finally, I designed “H” form strip with 70 inches long, 1 or 1.5 inches wide, its notch size is same as wood boards which is ¾ inch. If I put a certain size “H” form strips between wood boards when building a new fence (FIG. 1C), they would cover all the gaps later when the fence becomes old or dry. I guess that “H” form objects might have been used in industrial area. But I haven't seen any been used for fence privacy. I think I am the first one to use this idea for solving fence privacy problem. Because of its long, straight and simple structure, it would be easy to manufacture.

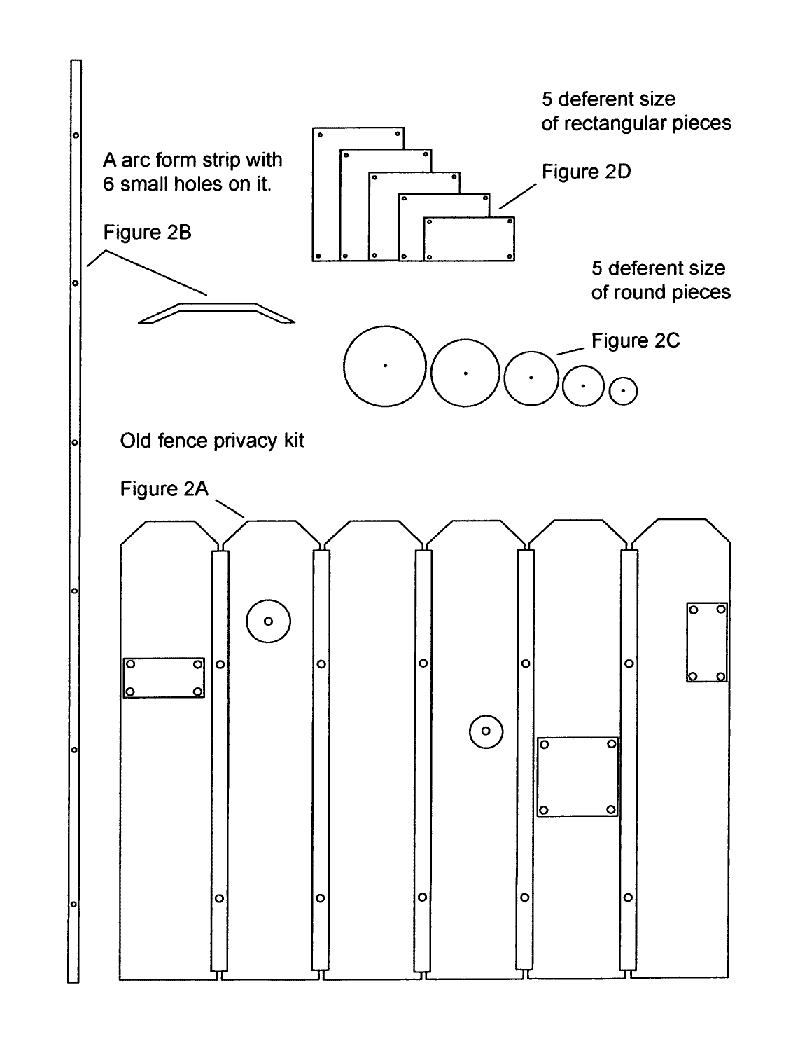

For an old, fixed fence, the best solution for its privacy issue is to use my old fence privacy kit to cover all the gaps (FIG. 2A). Inspired by “H” form strip, I designed a simple arc form strip to cover the gaps between wood boards because arc form would hold some pressure, then I designed deferent size of round and rectangular pieces to cover holes and cracks on fence. According to fence information I known, I made an arc form strip with 70 inches long, 1 or 1.5 inches wide, 2 mm in thickness, gray in color with wood grain, and with 6 small holes on it for fastening (FIG. 2B), the distance between each hole is 12 inches. For round Pieces, I made 5 deferent size of round covering pieces (FIG. 2C) in diameter of 1 inch, 1.5 inches, 2 inches, 2.5 inches and 3 inches, with a small hole on them for fastening. For rectangular pieces, I also made 5 deferent size of rectangular covering pieces (FIG. 2D) of 3×5 inch, 4×5 inch, 5×5 inch, 6×5 inch and 7×5 inch, with 4 holes in the corner of each piece. Both round and rectangular pieces would be made by PVC plastic, gray in color with wood grain on them to match old fence. I have seen vinyl fence, but I have never seen PVC products specially made for covering fence gaps. So I think I am the first person use the idea to solve fence privacy problem. Because of their simple designs, they would be easy to manufacture.

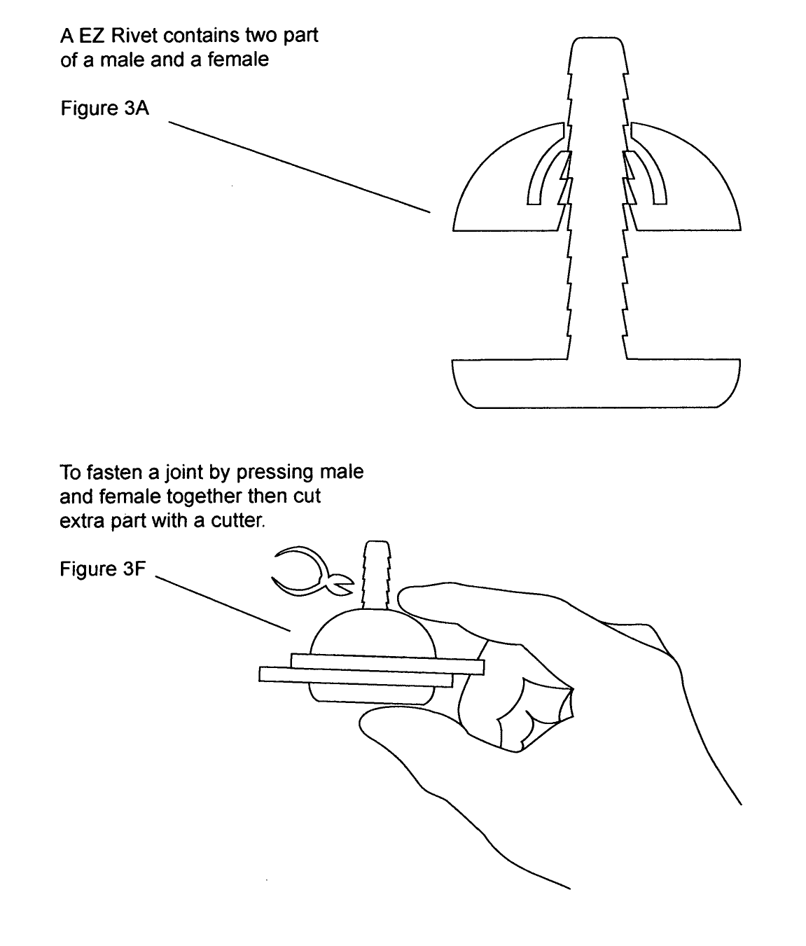

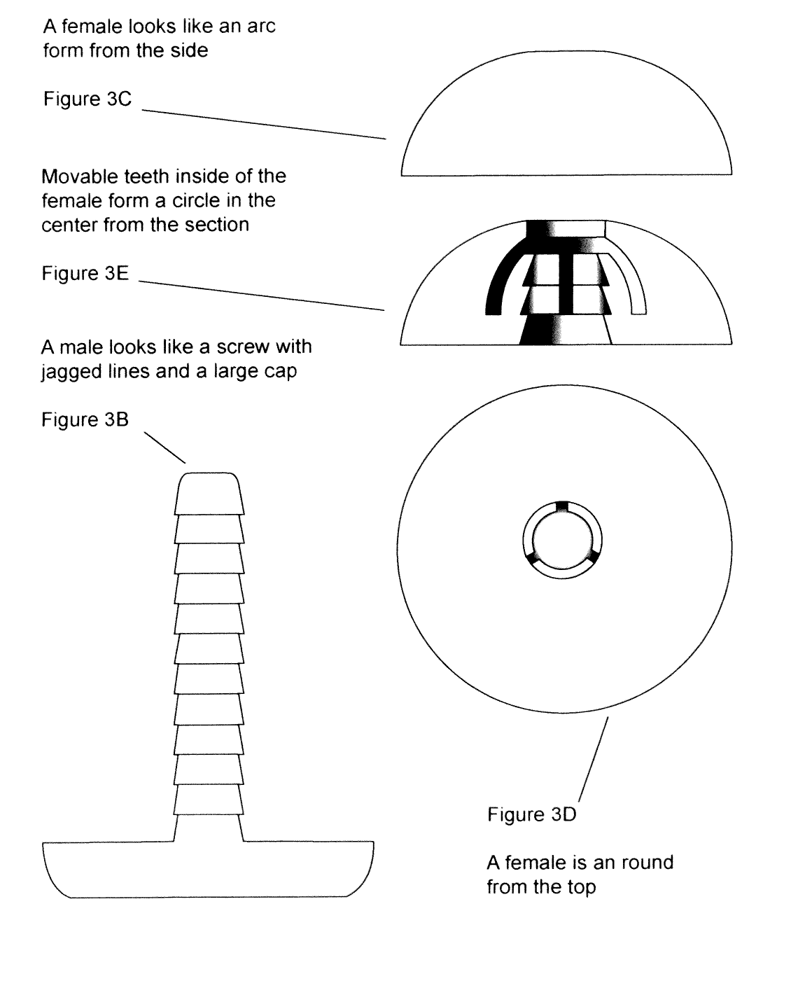

To fasten these covering pieces with the fence, I invented a fastener contains two part of a male and a female which I called EZ rivet (FIG. 3A). The mate part looks like a screw, because it comes with jagged lines and a large cap (FIG. 3B). Its diameter size is little bit smaller than the bottom and top holes of the female, its length can be any size depends on your needs. From the side, A female looks like an arc form with some thickness (FIG. 3C). From the top, it is an round(FIG. 3D). There is a hole in the center and the size of the hole is a little bigger than the male. From the section, there are three same size jagged movable teeth inside of the female form a circle in the center (FIG. 3E only see two teeth inside of the female from the section), and there are some space around them forming a smaller hole than the bottom and the top holes of the female. To fasten a joint, just insert a male into the bottom hole of the female, and press two parts together with your fingers and the male would be griped by movable teeth inside the female (FIGS. 3A & 3F), the male can only go in not out. Finally, to cut extra part of the male with a cutter, you would get a nice finish. This fastener would be made by plastic and would be manufactured too. It would perfectly work with my old fence privacy kit. I haven't seen such fasteners in the market. It would be broadly used in both residential and commercial area, every one can use it to finish their projects without using a special tool.

1. I designed a certain size of “H” form PVC strip used between wood boards when building a new wood fence to prevent gaps. By my research, I didn't see any type of “H” form PVC strips or products being used or related to the wood fence privacy issue. So I am the first person who designed and used it for building a new fence, it is an invention.

2. I designed a 70 inches long arc form PVC strip, and a certain size round and rectangular wood grain PVC pieces to cover gaps with a old wood fence. According to my research, I have never seen a product like mine to cover gaps with old wood fence in the market. I think I am the first person who designed and used the idea to solve the wood fence privacy problem. So it is an invention.

3. I designed a EZ rivet for fastening covering pieces with old fence. According to my research, I have never seen any fasteners in the market like my EZ rivet would work with any objects and materials without using a special tool. It is easy and fast to use, also with nice finish on both side, and would be broadly used in many areas. I think I am the first person who designed this kind of fasteners, it is a real invention.
